(19) United States
(12) Patent Application Publication
(10) Pub. No.: US 2024/0362048 A1
(43) Pub. Date: Oct. 31, 2024

(54) Kubernetes Integrated Chargeback and Limits Management

(71) Applicants: Robin Systems, Inc, San Jose, CA (US); Robin Software Development Center India Pirvate Limited, Bangalore (IN)

(72) Inventors: Tushar Anil Doshi, Santa Clara, CA (US); Rishi Mundada, Bangalore (IN)

(21) Appl. No.: 18/250,870

(22) PCT Filed: Dec. 9, 2022
(86) PCT No.: PCT/US2022/052389

§ 371 Date: Apr. 27, 2023

(51) Int. Cl. G06F 9/455; H04L 47/783; H04L 67/02

(52) U.S. Cl. CPC G06F 9/45558; H04L 47/783; H04L 67/02; G06F 2009/45583; G06F 2009/45595

(57) ABSTRACT

Systems and methods for tracking resource usage on a network computing platform such as Kubernetes. A method includes establishing a resource allotment for a time period for a customer utilizing a network computing platform. The method includes receiving a custom callback from a webhook associated with the network computing platform, wherein the custom callback indicates the customer seeks to perform an action on the network computing platform. The method includes calculating a resource requirement for the action, calculating an up-to-date resource usage for the customer for the time period, and approving or denying the action based on whether the customer comprises sufficient remaining resources for the time period.

### TECHNICAL FIELD

This disclosure relates generally to compute system configurations and specifically to tracking resource usage on a network computing platform.

### SUMMARY

Systems and methods for tracking resource usage on a network computing platform such as Kubernetes. A method includes establishing a resource allotment for a time period for a customer utilizing a network computing platform. The method includes receiving a custom callback from a webhook associated with the network computing platform, wherein the custom callback indicates the customer seeks to perform an action on the network computing platform. The method includes calculating a resource requirement for the action, calculating an up-to-date resource usage for the customer for the time period, and approving or denying the action based on whether the customer comprises sufficient remaining resources for the time period.

### BACKGROUND

Numerous industries benefit from and rely upon cloud-based computing resources to store data, access data, and run applications based on the stored data. In some cases, external entities manage and assist customers in using cloud-based network computing platforms such as Kubernetes®. These external entities may seek to manage resource allocations to different customers by prohibiting customers from exceeding resource allocations and charging customers on for actual resource use. However, Kubernetes and other cloud-based network computing platforms do not track per-user resource usage on an aggregated level. Thus, there is a need to establish an integrated means for tracking resource usage within a network computing platform such as Kubernetes.

In view of the foregoing, disclosed herein are systems, methods, and devices for integrated resource tracking and resource allocation on network computing platforms.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a schematic block diagram of a system for automated deployment, scaling, and management of containerized workloads and services, wherein the system draws on storage distributed across shared storage resources;

FIG. 1B is a schematic block diagram of a system for automated deployment, scaling, and management of containerized workloads and services, wherein the system draws on storage within a stacked storage cluster;

FIG. 2 is a schematic block diagram of a system for automated deployment, scaling, and management of containerized applications;

FIG. 3 is a schematic block diagram illustrating a system for managing containerized workloads and services;

FIG. 4 is a schematic block diagram illustrating a system multi-team tenancy within a cluster, and for assigning permissions to users associated with the cluster;

FIG. 5 is a schematic block diagram of an example namespace configuration for a cluster;

FIG. 6 is a schematic block diagram of an example cluster comprising a namespace, wherein a plurality of compute nodes and pods are mapped to the namespace;

FIG. 7 is a schematic block diagram of a system for integrated tracking of resource usage within a cluster of a network computing platform such as Kubernetes;

FIG. 8 is a schematic block diagram of an example process flow for approving or denying an action to be executed on a cluster based on a customer's remaining resource allocation over a time period;

FIG. 9 is a schematic flow chart diagram of a method for integrated tracking of resource usage within a network computing platform; and

FIG. 10 is a schematic block diagram of an example computing device suitable for implementing methods in accordance with embodiments of the invention.

### DETAILED DESCRIPTION

Disclosed herein are systems, methods, and devices for tracking per-user and per-tenant resource usage within a containerized workload management system such as Kubernetes®. The systems, methods, and devices described herein are particularly implemented to ensure that different customers are segregated from one another when performing operations on the same cluster. Additionally, the systems, methods, and devices described herein are implemented to track resource usage by different customers, users, and tenants, and further to chargeback resource usage for different customers, users, and tenants.

The Kubernetes platform is widely used across industries to support workload management and workload execution. However, Kubernetes manages resource usage on a per-namespace level, rather than a per-user or per-tenant level. Additionally, Kubernetes does not provide a means to generate chargeback reports to invoice customers for their actual resource usage. The systems, methods, and devices described herein are configured to integrate with the Kubernetes platform using webhooks to track resource usage in real-time of different users, tenants, and customers.

Some administrative systems utilize the Kubernetes platform and manage client workloads within the Kubernetes platform. In some cases, these administrative systems maintain resource usage on a per-user, per-tenant, and global per-customer basis. These systems desire to track usage across all objects, and may issue chargeback reports per-tenant, per-user, and/or per-customer to invoice for actual resource usage. The process of tracking resource usage and issuing chargebacks can be elaborate and complex, and it becomes more challenging when seeking to integrate resource tracking with another platform such as Kubernetes.

The systems, methods, and devices described herein provide a simplified means for integrating with the Kubernetes platform to track actual resource usage, approve or deny actions based on resource usage, and issue chargebacks based on resource usage. The systems, methods, and devices described herein enable administrative systems to reject actions if the action would exceed resources allocated to a customer, user, tenant, and so forth.

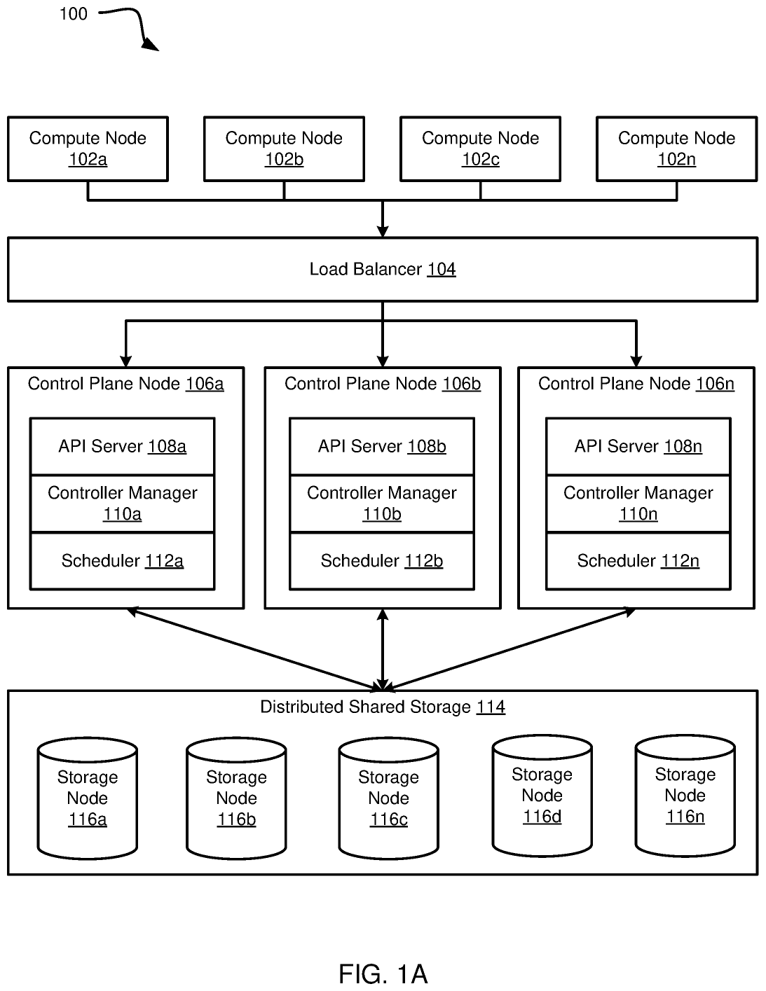

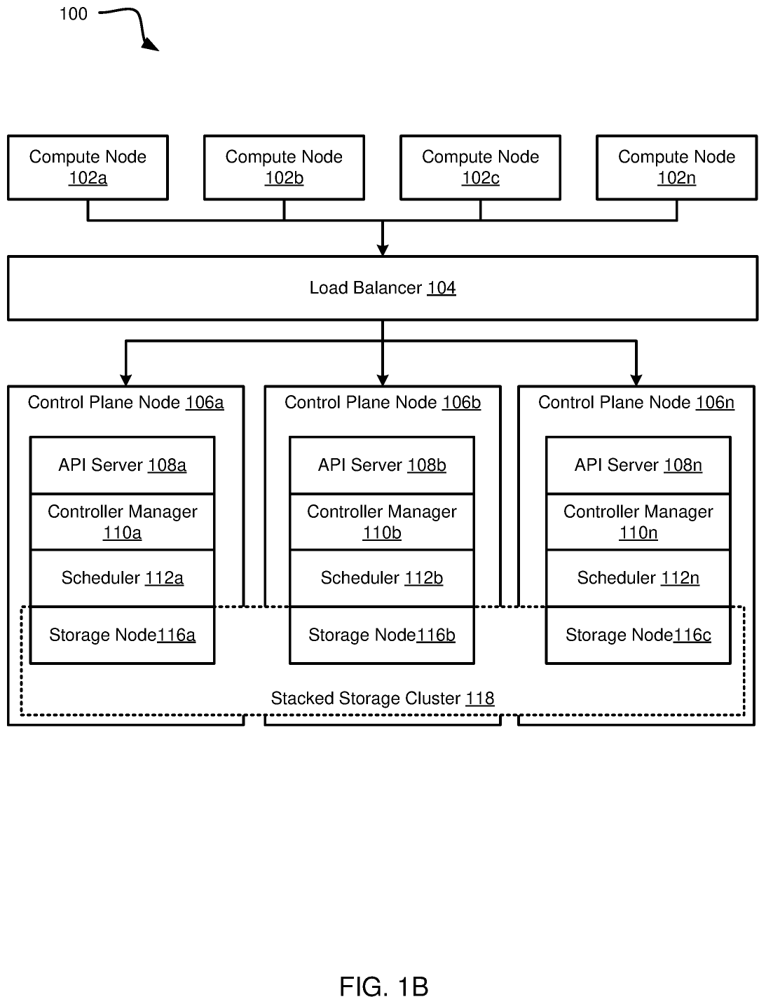

Referring now to the figures, FIGS. 1A and 1B are schematic illustrations of an example system 100 for automated deployment, scaling, and management of containerized workloads and services. The system 100 facilitates declarative configuration and automation through a distributed platform that orchestrates different compute nodes that may be controlled by central master nodes. The system 100 may include “n” number of compute nodes that can be distributed to handle pods.

The system 100 includes a plurality of compute nodes 102a, 102b, 102c, 102n (may collectively be referred to as compute nodes 102 as discussed herein) that are managed by a load balancer 104. The load balancer 104 assigns processing resources from the compute nodes 102 to one or more of the control plane nodes 106a, 106b, 106n (may collectively be referred to as control plane nodes 106 as discussed herein) based on need. In the example implementation illustrated in FIG. 1A, the control plane nodes 106 draw upon a distributed shared storage 114 resource comprising a plurality of storage nodes 116a, 116b 116c, 116d, 116n (may collectively be referred to as storage nodes 116 as discussed herein). In the example implementation illustrated in FIG. 1B, the control plane nodes 106 draw upon assigned storage nodes 116 within a stacked storage cluster 118.

The control planes 106 make global decisions about each cluster and detect and responds to cluster events, such as initiating a pod when a deployment replica field is unsatisfied. The control plane node 106 components may be run on any machine within a cluster. Each of the control plane nodes 106 includes an API server 108, a controller manager 110, and a scheduler 112.

The API server 108 functions as the front end of the control plane node 106 and exposes an Application Program Interface (API) to access the control plane node 106 and the compute and storage resources managed by the control plane node 106. The API server 108 communicates with the storage nodes 116 spread across different clusters. The API server 108 may be configured to scale horizontally, such that it scales by deploying additional instances. Multiple instances of the API server 108 may be run to balance traffic between those instances.

The controller manager 110 embeds core control loops associated with the system 100. The controller manager 110 watches the shared state of a cluster through the API server 108 and makes changes attempting to move the current state of the cluster toward a desired state. The controller manager 110 may manage one or more of a replication controller, endpoint controller, namespace controller, or service accounts controller.

The scheduler 112 watches for newly created pods without an assigned node, and then selects a node for those pods to run on. The scheduler 112 accounts for individual and collective resource requirements, hardware constraints, software constraints, policy constraints, affinity specifications, anti-affinity specifications, data locality, inter-workload interference, and deadlines.

The storage nodes 116 function as a distributed storage resources with backend service discovery and database. The storage nodes 116 may be distributed across different physical or virtual machines. The storage nodes 116 monitor changes in clusters and store state and configuration data that may be accessed by a control plane node 106 or a cluster. The storage nodes 116 allow the system 100 to support discovery service so that deployed applications can declare their availability for inclusion in service.

In some implementations, the storage nodes 116 are organized according to a key-value store configuration, although the system 100 is not limited to this configuration. The storage nodes 116 may create a database page for each record such that the database pages do not hamper other records while updating one. The storage nodes 116 may collectively maintain two or more copies of data stored across all clusters on distributed machines.

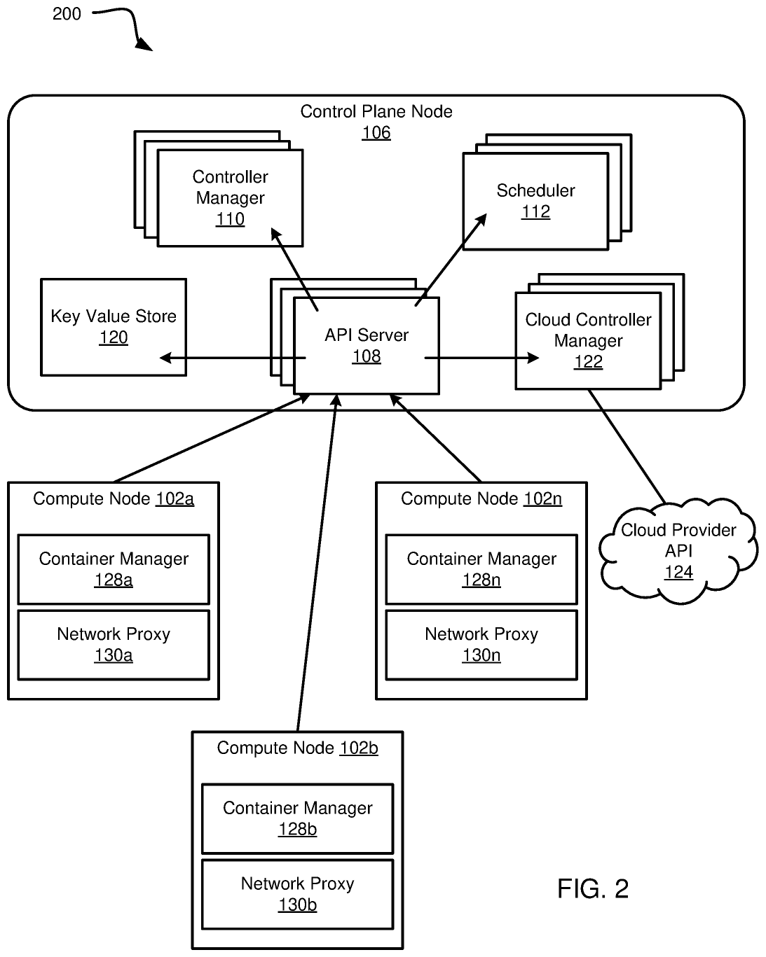

FIG. 2 is a schematic illustration of a cluster 200 for automating deployment, scaling, and management of containerized applications. The cluster 200 illustrated in FIG. 2 is implemented within the systems 100 illustrated in FIGS. 1A-1B, such that the control plane node 106 communicates with compute nodes 102 and storage nodes 116 as shown in FIGS. 1A-1B. The cluster 200 groups containers that make up an application into logical units for management and discovery.

The cluster 200 deploys a cluster of worker machines, identified as compute nodes 102a, 102b, 102n. The compute nodes 102a-102n run containerized applications, and each cluster has at least one node. The compute nodes 102a-102n host pods that are components of an application workload. The compute nodes 102a-102n may be implemented as virtual or physical machines, depending on the cluster. The cluster 200 includes a control plane node 106 that manages compute nodes 102a-102n and pods within a cluster. In a production environment, the control plane node 106 typically manages multiple computers and a cluster runs multiple nodes. This provides fault tolerance and high availability.

The key value store 120 is a consistent and available key value store used as a backing store for cluster data. The controller manager 110 manages and runs controller processes. Logically, each controller is a separate process, but to reduce complexity in the cluster 200, all controller processes are compiled into a single binary and run in a single process. The controller manager 110 may include one or more of a node controller, job controller, endpoint slice controller, or service account controller.

The cloud controller manager 122 embeds cloud-specific control logic. The cloud controller manager 122 enables clustering into a cloud provider API 124 and separates components that interact with the cloud platform from components that only interact with the cluster. The cloud controller manager 122 may combine several logically independent control loops into a single binary that runs as a single process. The cloud controller manager 122 may be scaled horizontally to improve performance or help tolerate failures.

The control plane node 106 manages any number of compute nodes 126. In the example implementation illustrated in FIG. 2, the control plane node 106 is managing three nodes, including a first node 126a, a second node 126b, and an nth node 126n (which may collectively be referred to as compute nodes 126 as discussed herein). The compute nodes 126 each include a container manager 128 and a network proxy 130.

The container manager 128 is an agent that runs on each compute node 126 within the cluster managed by the control plane node 106. The container manager 128 ensures that containers are running in a pod. The container manager 128 may take a set of specifications for the pod that are provided through various mechanisms, and then ensure those specifications are running and healthy.

The network proxy 130 runs on each compute node 126 within the cluster managed by the control plane node 106. The network proxy 130 maintains network rules on the compute nodes 126 and allows network communication to the pods from network sessions inside or outside the cluster.

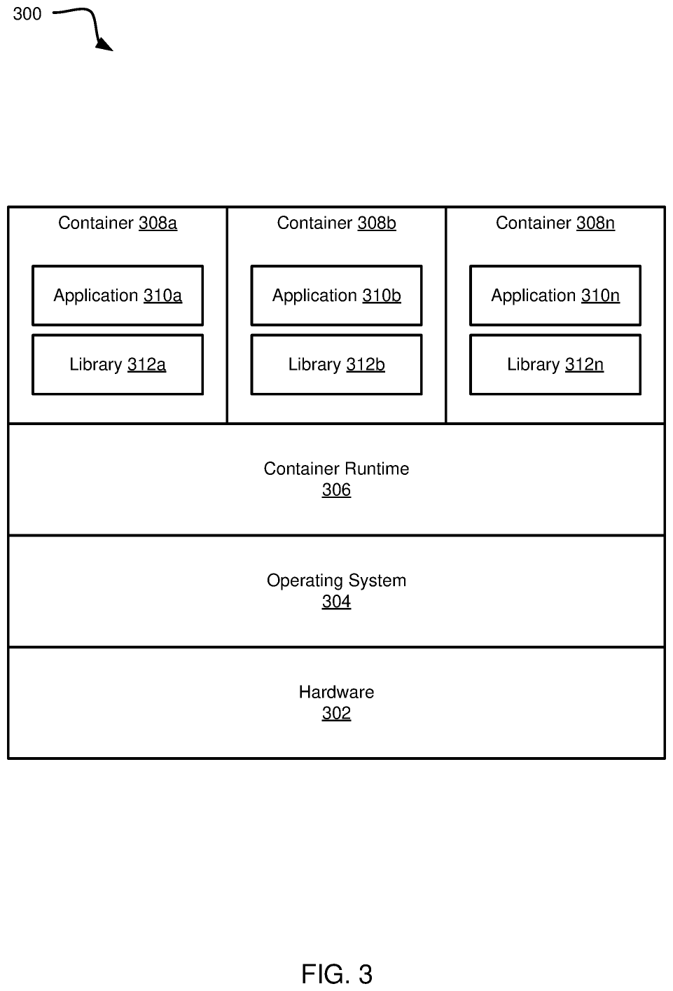

FIG. 3 is a schematic diagram illustrating a system 300 for managing containerized workloads and services. The system 300 includes hardware 302 that supports an operating system 304 and further includes a container runtime 306, which refers to the software responsible for running containers 308. The hardware 302 provides processing and storage resources for a plurality of containers 308a, 308b, 308n that each run an application 310 based on a library 312. The system 300 discussed in connection with FIG. 3 is implemented within the systems 100, 200 described in connection with FIGS. 1A-1B and 2.

The containers 308 function similar to a virtual machine but have relaxed isolation properties and share an operating system 304 across multiple applications 310. Therefore, the containers 308 are considered lightweight. Similar to a virtual machine, a container has its own file systems, share of CPU, memory, process space, and so forth. The containers 308 are decoupled from the underlying instruction and are portable across clouds and operating system distributions.

Containers 308 are repeatable and may decouple applications from underlying host infrastructure. This makes deployment easier in different cloud or OS environments. A container image is a ready-to-run software package, containing everything needed to run an application, including the code and any runtime it requires, application and system libraries, and default values for essential settings. By design, a container 308 is immutable such that the code of a container 308 cannot be changed after the container 308 begins running.

The containers 308 enable certain benefits within the system. Specifically, the containers 308 enable agile application creation and deployment with increased ease and efficiency of container image creation when compared to virtual machine image use. Additionally, the containers 308 enable continuous development, integration, and deployment by providing for reliable and frequent container image build and deployment with efficient rollbacks due to image immutability. The containers 308 enable separation of development and operations by creating an application container at release time rather than deployment time, thereby decoupling applications from infrastructure. The containers 308 increase observability at the operating system-level, and also regarding application health and other signals. The containers 308 enable environmental consistency across development, testing, and production, such that the applications 310 run the same on a laptop as they do in the cloud. Additionally, the containers 308 enable improved resource isolation with predictable application 310 performance. The containers 308 further enable improved resource utilization with high efficiency and density.

The containers 308 enable application-centric management and raise the level of abstraction from running an operating system 304 on virtual hardware to running an application 310 on an operating system 304 using logical resources. The containers 304 are loosely coupled, distributed, elastic, liberated micro-services. Thus, the applications 310 are broken into smaller, independent pieces and can be deployed and managed dynamically, rather than a monolithic stack running on a single-purpose machine.

The containers 308 may include any container technology known in the art such as DOCKER, LXC, LCS, KVM, or the like. In a particular application bundle 406, there may be containers 308 of multiple distinct types in order to take advantage of a particular container's capabilities to execute a particular role 416. For example, one role 416 of an application bundle 406 may execute a DOCKER container 308 and another role 416 of the same application bundle 406 may execute an LCS container 308.

The system 300 allows users to bundle and run applications 310. In a production environment, users may manage containers 308 and run the applications to ensure there is no downtime. For example, if a singular container 308 goes down, another container 308 will start. This is managed by the control plane nodes 106, which oversee scaling and failover for the applications 310.

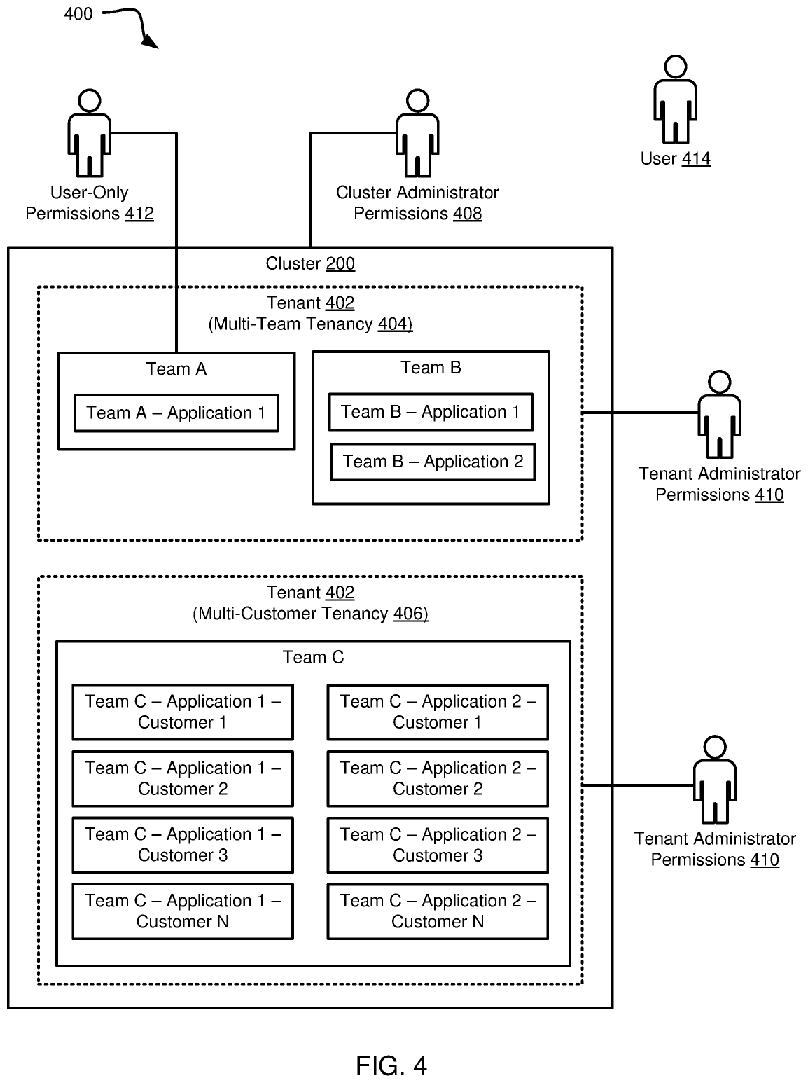

FIG. 4 is a schematic block diagram of an example tenancy scheme 400 with coexisting tenancy models within a single cluster 200. Tenants 402 are a system construct that enable users 414 to be organized into described groups based on function or business requirements. A user 414 may be a member of multiple tenants 402, but each user 414 is only able to access resources that are bound to the tenant they are currently logged into (i.e., a user 414 would not be able to access an application they deployed in one tenant when they were logged into a different tenant). In the systems described herein, a tenant includes one or more of a team responsible for developing and operating one or more workloads, a set of related workloads (whether operated by one or more teams), or a single workload such as a deployment. Cluster multi-tenancy as shown in FIG. 4 is often implemented to reduce costs or to consistently apply administration policies across tenants 402.

Each person accessing the cluster 200 does so with a unique account. The user account includes a username and identifier that uniquely identifies the user 414 within the cluster 200. All objects created by the user (including, e.g., applications) will be tagged with the user's identifier. The user account includes key attributes about the user 414, such as first and last name, email address, phone number, and so forth, and provides a means for authenticating the user 414 when they log into the cluster 200.

Each user 414 that logs into the cluster 200 has a set of permission mappings that determine which operations they can perform on which object types. The set of permission mappings is determined by which user capabilities have been assigned to the user 414 for the tenant 402 they are currently logged into. A user's 414 current permissions are the set of all permission mappings assigned to the user 414 based on their assigned user capabilities plus those from inherited capabilities. Users 414 may be mapped to multiple tenants 402, and users 414s who are assigned to multiple tenants 402 can have a different role and permissions for each tenant 402 they are a member of. In an example system, users 414 may be granted cluster administrator permissions 408, tenant administrator permissions 410, and/or user-only permissions 412.

Users 414 having cluster administrator permissions 408 have full access to all cluster 200 objects and resources, including those bound to individual tenants 402. Users 414 with cluster administrator permissions 408 are able to perform all administrative functions within the cluster 200, such as adding users 414 to the cluster 200, registering and sharing storage repositories, exporting/importing application backups, and so forth.

Users 414 with tenant administrator permissions 410 have many of the same permissions as users with cluster administrator permissions 408, but their scope is limited to a particular tenant 402 within the cluster 200. A user 414 with tenant administrator permissions 410 is able to view resources bound to their respective tenant 402, can register and share storage repositories, export/import application backups, and so forth.

Users 414 assigned user-only permissions 412 have no cluster 200 or tenant 402 administrative capabilities are generally limited to managing applications they have deployed or registered. Additionally, a system administrator may grant custom user capabilities the enable those with user-only permissions 412 to perform limited administrative tasks.

The example cluster 200 depicted in FIG. 4 is shared by multiple tenants 402. This configuration reduces costs and simplifies administration of the system. However, cluster sharing amongst tenants 402 presents challenges such as security, fairness, and managing co-tenant members that monopolize bandwidth, disk input/output, compute resources, and so forth. Clusters 200 may be shared in numerous ways. In some cases, different applications are executed by the same cluster 200 as shown in FIG. 4, wherein the cluster 200 is running each of Application 1 and Application 2. Additionally, a single cluster 200 may execute multiple instances of the same application, with one application instance for each customer. This is depicted in FIG. 4, wherein the cluster 200 is running Application 1 for each of Customer 1, Customer 2, Customer 3, and up through Customer N.

The example tenancy scheme 400 illustrated in FIG. 4 implements multi-team tenancy 404 and multi-customer tenancy 406. Multi-team tenancy 404 is commonly employed when sharing a cluster 200 between multiple teams within an organization. In multi-team tenancy 404, a tenant 402 is typically a team, where each team typically deploys a small number of workloads that scales with the complexity of the service. Multi-team tenancy 404 enables each team within the organization to operate one or more workloads executed by the cluster 200. These workloads frequently need to communicate with each other and with other workloads located on the same or different clusters. In this scenario, members of the teams often have direct access to system resources or indirect access through GitOps controllers or other types of release automation tools.

Multi-customer tenancy 406 is commonly employed when deploying a Software-as-a-Service (SaaS). In multi-customer tenancy 406, a tenant member typically includes one or more customers who share a single workload. Each “customer” may be as large as an entire company or as small as a single team within that company. In multi-customer tenancy 406, the cluster 200 runs multiple instances of a workload to accommodate multiple customers. In this scenario, users 414 do not have access to the cluster 200. Cost optimization is frequently a critical concern, and the cluster 200 may be configured to ensure that workloads for the various customers are strongly isolated from each other.

In many cases, the same organization may use both types of tenants 402 in different contexts. For example, a platform team may offer shared services such as security tools and databases to multiple internal customers and a SaaS customer may also have multiple teams sharing a development cluster. In an example implementation, a SaaS provider uses a combination of per-customer workloads for sensitive data, combined with multi-tenant shared services.

The control plane node 106 of the cluster 200 may apply the tenancy configurations as an organization requirement. The control plane node 106 may implement various isolations levels, including “hard” multi-tenancy with strong isolation or “soft” multi-tenancy with weaker isolation. Hard multi-tenancy is typically implemented when tenant members do not trust each other from security and resource sharing perspectives. In some cases, it may be necessary to forgo multi-tenancy cluster sharing and assign each tenant 402 a dedicated cluster, possibly even running on dedicated hardware if virtual machines are not considered an adequate security boundary.

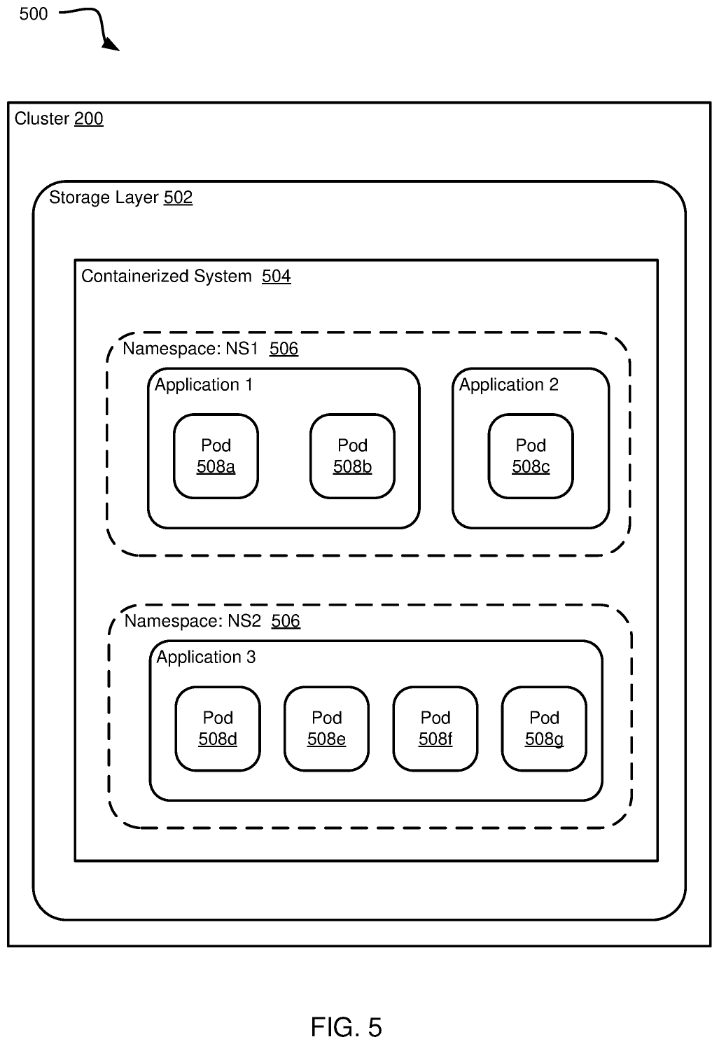

FIG. 5 is a schematic block diagram of an example namespace configuration 500 for a cluster 200. The Kubernetes platform tracks resource usage on a per-namespace level, rather than a per-user or per-tenant level. As described herein, a single customer or tenant may be associated with multiple namespaces, and it may be desirable to ensure the customer or tenant remains within their usage allotment across multiple aggregated namespaces.

The namespace configuration 500 illustrated in FIG. 5 may be implemented with the multi-tenant configuration discussed in connection with FIG. 4. The namespaces described herein enable a cluster 200 to be partitioned into multiple “virtual clusters.” Names for resources deployed in a namespace 506 must be unique, but that restriction does not apply across namespaces 506. In addition to isolating application resources, namespaces 506 also provide a way to isolate groups of customers (i.e., users 414 within a tenant 402) and apportion cluster resources to those groups.

The example cluster 200 illustrated in FIG. 5 includes a storage layer 502 and a containerized system 504 operating in connection with the storage layer 502. The containerized system 504 may include the components discussed in connection with FIGS. 1-3 for executing containerized workloads. The example containerized system 504 depicted in FIG. 5 includes two different namespaces 506, including a first namespace NS1 and a second namespace NS2. The namespaces 506 provide a mechanism for isolating groups of API resources within a single cluster 200. Many system-wide security policies are scoped to namespaces 506. In a multi-tenant environment such as the tenancy scheme 400 illustrated in FIG. 4, a namespace 506 helps segment a tenant's workload into a logical and distinct management units. In some cases, system administrators will isolate each workload to its own namespace 506, even if multiple workloads are operated by the same tenant 402. This ensures that each workload has its own identity and can be configured with an appropriate security policy.

In the example illustrated in FIG. 5, there are two applications mapped to the first namespace NS1, including Application 1 and Application 2. Application 1 is executed by two pods, including pod 508a and pod 508b. Application 2 is executed by a single pod 508c. The second namespace NS2 is dedicated to a single application, namely Application 3. Application 3 is executed by numerous pods, including pod 508d-508g.

The control plane node 106 of the cluster 200 implements role-based access control (RBAC) to enforce authorization for both customers and workloads. In a multi-team tenancy 404, the control plane node 106 implements RBAC to restrict tenant members' access to appropriate namespaces 506 and ensure that cluster-wide 200 resources can only be accessed or modified by privileged users 414 such as those with cluster administrator permissions 408. If a policy grants a user 414 more permissions than the user 414 needs, this typically signals that the namespace 506 containing the affected resources should be refactored into finger-grained namespaces 506.

The tenants 402 are isolated within the data plane (see storage layer 502) to ensure that pods 508 and workloads for different tenants 402 are sufficiently isolated. By default, all pods within a cluster 200 are allowed to communicate with one another and all network traffic is unencrypted. This can lead to security vulnerabilities where traffic is accidentally or maliciously sent to an unintended destination or is intercepted by a workload on a compromised node. Pod-to-pod communication can be controlled using network policies that restrict communication between pods 508 using namespace labels or IP address ranges. In a multi-tenant environment such as the one illustrated in FIG. 4, where strict network isolation between tenants 402 is required, it may be beneficial to implement a default policy that denies communication between pods 508. With this strict default policy in place, a system administrator may add more permissive rules that allow for communication within a single namespace 506.

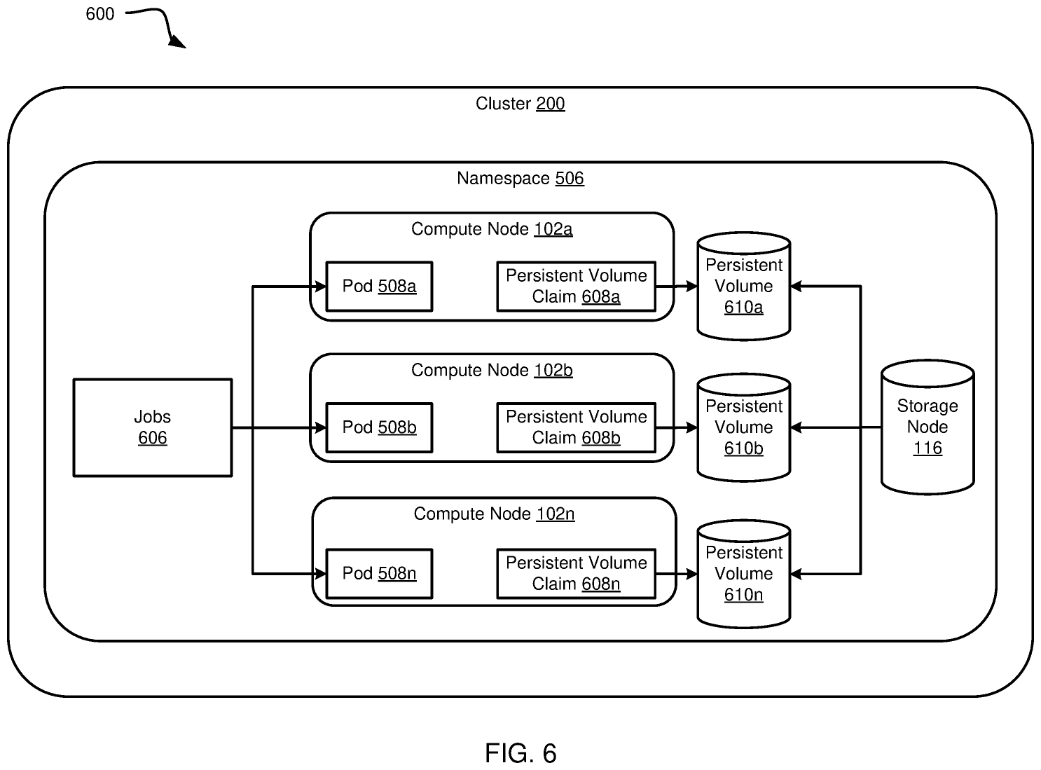

FIG. 6 is a schematic diagram of an example system 600 for executing jobs with one or more compute nodes associated with a cluster. The system 600 includes a cluster 200, such as the cluster first illustrated in FIG. 2. The cluster 200 includes a namespace 506. Several compute nodes 102 are bound to the namespace 506, and each compute node 102 includes a pod 508 and a persistent volume claim 608. In the example illustrated in FIG. 6, the namespace 506 is associated with three compute nodes 102a, 102b, 102n, but it should be appreciated that any number of compute nodes 102 may be included within the cluster 200. The first compute node 102a includes a first pod 508a and a first persistent volume claim 608a that draws upon a first persistent volume 610a. The second compute node 102b includes a second pod 508b and a second persistent volume claim 608b that draws upon a second persistent volume 610b. Similarly, the third compute node 102n includes a third pod 508n and a third persistent volume claim 608n that draws upon a third persistent volume 610n. Each of the persistent volumes 610 may draw from a storage node 116. The cluster 200 executes jobs 606 that feed into the compute nodes 102 associated with the namespace 506.

Numerous storage and compute nodes may be dedicated to different namespaces 602 within the cluster 200. The namespace 506 may be referenced through an orchestration layer by an addressing scheme, e.g., <Bundle ID>.<Role ID>.<Name>. In some embodiments, references to the namespace 506 of another job 606 may be formatted and processed according to the JINJA template engine or some other syntax. Accordingly, each task may access the variables, functions, services, etc. in the namespace 506 of another task on order to implement a complex application topology.

Each job 606 executed by the cluster 200 maps to one or more pods 508. Each of the one or more pods 508 includes one or more containers 608. Each resource allocated to the application bundle is mapped to the same namespace 506. The pods 508 are the smallest deployable units of computing that may be created and managed in the systems described herein. The pods 508 constitute groups of one or more containers 608, with shared storage and network resources, and a specification of how to run the containers 608. The pods' 508 contents are co-located and co-scheduled and run in a shared context. The pods 508 are modeled on an application-specific “logical host,” i.e., the pods 508 include one or more application containers 608 that are relatively tightly coupled.

The pods 508 are designed to support multiple cooperating processes (as containers 608) that form a cohesive unit of service. The containers 608 in a pod 508 are co-located and co-scheduled on the same physical or virtual machine in the cluster. The containers 608 can share resources and dependencies, communicate with one another, and coordinate when and how they are terminated. The pods 508 may be designed as relatively ephemeral, disposable entities. When a pod 508 is created, the new pod 508 is schedule to run on a node in the cluster. The pod 508 remains on that node until the pod 508 finishes executing, and then the pod 508 is deleted, evicted for lack of resources, or the node fails.

The system 600 is valuable for applications that require one or more of the following: stable and unique network identifiers; stable and persistent storage; ordered and graceful deployment and scaling; or ordered and automated rolling updated. In each of the foregoing, “stable” is synonymous with persistent across pod rescheduling. If an application does not require any stable identifiers or ordered deployment, deletion, or scaling, then the application may be deployed using a workload object that provides a set of stateless replicas.

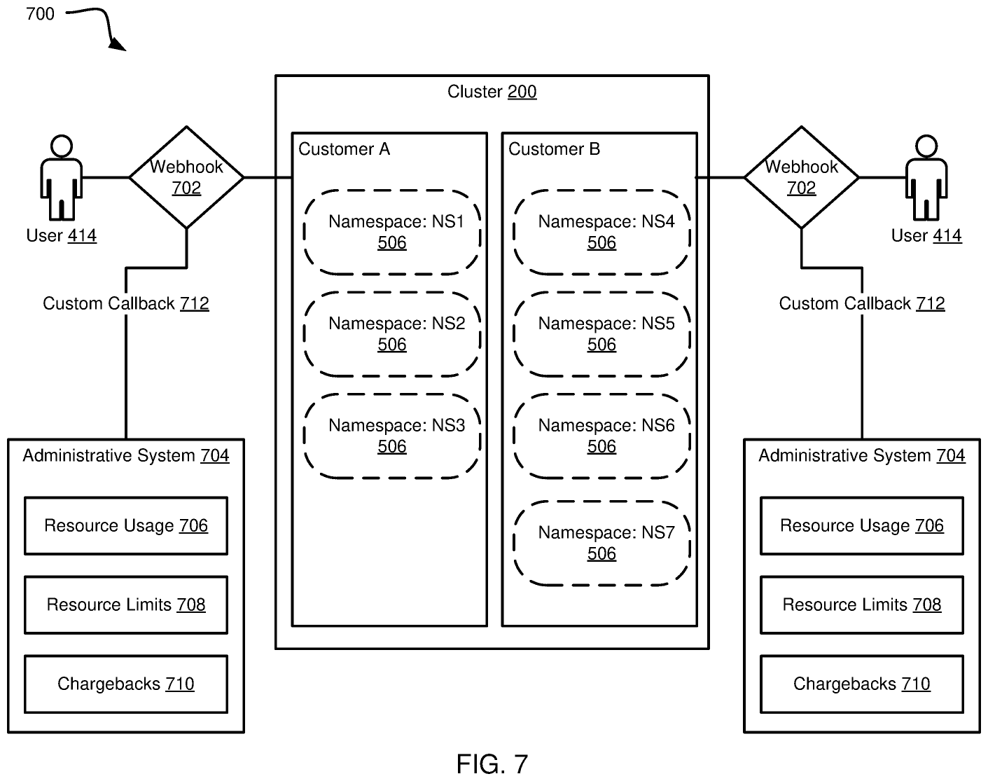

FIG. 7 is a schematic diagram of an example system 700 for tracking real-time resource usage of multiple different customers operating on the same cluster.

The example cluster 200 illustrated in FIG. 7 includes two customer accounts, including Customer A and Customer B. It should be appreciated that Customer A and Customer B may each govern any number of namespaces depending on their own resource needs and implementations. In the example shown in FIG. 7, Customer A utilizes three namespaces 506 within the cluster 200, including NS1, NS2, and N3, and Customer B utilizes four namespaces 506 within the cluster 200, including NS4, NS5, NS6, and NS7.

There is at least one user 414 authorized to administer on each of the respective customer accounts. When a user 414 seeks to alter configurations within their respective customer account, the system 700 executes a custom callback 712 by way of a webhook 702. The custom callback 712 communicates with an administrative system outside the Kubernetes platform. The administrative system 704 may include a compute resources vendor such as Robin® or Amazon Web Services®. The administrative system 704 is configured to track resource usage 706, resource limits 708, and chargebacks for the respective customer accounts.

The webhook 702 provides a means to augment or alter the behavior of a web application with the custom callback 712. The custom callback 712 may be maintained, modified, and managed by third-party users and developers who may not necessarily be affiliated with the originating website or application. In the example system 700 illustrated in FIG. 7, the custom callback 712 may be managed by the administrative system 704 operating outside the Kubernetes platform, and the cluster 200 may be operating within the Kubernetes platform. The custom callback 712 is a user-defined HTTP callback that is triggered by an event, such as the user 414 pushing code to a repository, seeking to create a new pod 508 within a namespace 506, seeking to alter storage resources within a namespace 506, and so forth. When the event occurs, the source sit (in this case, the Kubernetes cluster 200) makes an HTTP request to the URL configured for the webhook 702. The administrative system 704 can configure the webhook 702 to cause events on one site (the Kubernetes cluster 200) to invoke behavior on another site (the administrative system 704).

The administrative system 704 maintains resource usage 706 data on a per-user, per-tenant, and per-customer level in terms of all resources, including CPU (central processing unit), memory, storage, network, GPU (graphics processing unit), and so forth. The administrative system 704 tracks resource usage 706 across all objects, including clusters 200, namespaces 506, applications, compute nodes 102, pods 508, persistent volumes 610, storage nodes 116, and so forth. The administrative system 704 further tracks resource usage 706 for all users 414, all tenants 402, for groupings of users with different permission levels 408-418, and for customers as a whole. A single customer may include multiple tenants and tens or hundreds of users, and the administrative system 704 tracks the resource usage 706 in real-time for all resources.

The administrative system 704 maintains resource limits 708 for customer accounts, individual users, individual tenants, groups of tenants, individual applications, individual namespaces, individual clusters, and so forth, depending on customer preferences. The administrative system 704 is capable of tracking the customer's aggregate usage across multiple users, tenants, applications, namespaces, clusters, and so forth, even when the customer is using resources within the Kubernetes platform.

The Kubernetes platform only tracks resource usage on a per-namespace level. In an example implementation, Customer A is allocated 4 CPU and 8 GB on NS1, 5 CPU and 10 GB on NS2, and 5 CPU and 12 GB on NS3. The Kubernetes platform is capable of tracking Customer A's resource usage 706 on the individual namespaces 506. However, the Kubernetes platform cannot track Customer A's aggregate usage across multiple namespaces NS1-NS3. The administrative system 704, however, can track Customer A's resource usage 706 across the three namespaces NS1-NS3 by way of the webhook 702 custom callback 712. Further to the above example, the administrative system 704 may allocate an aggregate resource limit 708 on Customer A comprising 100 CPU, 500 GB, and 1 TB of storage. In this implementation, Customer A may utilize resources across the various namespaces 506, and the administrative system 704 will only limit Customer A's resources on an aggregate basis across its multiple namespaces NS1-NS3.

The administrative system 704 further tracks resource usage 706 for purposes of issuing chargebacks 710 to invoice customers for their actual resource usage. In some cases, customers elect to pay based on actual resource usage. In other cases, customers elect to pay a flat rate, and then pay on a per-usage basis for any resources used above a threshold amount. For example, a customer may initially have a resource allotment of 50 CPU, 100 GB, and 500 GB storage per month. If the customer utilizes one or more of these resources in full in a month and wishes to add additional resources, the customer may contact the administrative system 704 to raise the allotment to, for example, 80 CPU, 200 GB, and 800 GB storage for subsequent months.

In some cases, the customer may wish to pay for the initial resource allotment as a flat rate and pay an additional flat rate for opportunity to draw upon the additional allotment, but ultimately pay on a per-usage basis for any resources used above the initial allotment. In this example implementation, the administrative system 704 will issue chargebacks 710 to invoice the customer for their actual usage of resources.

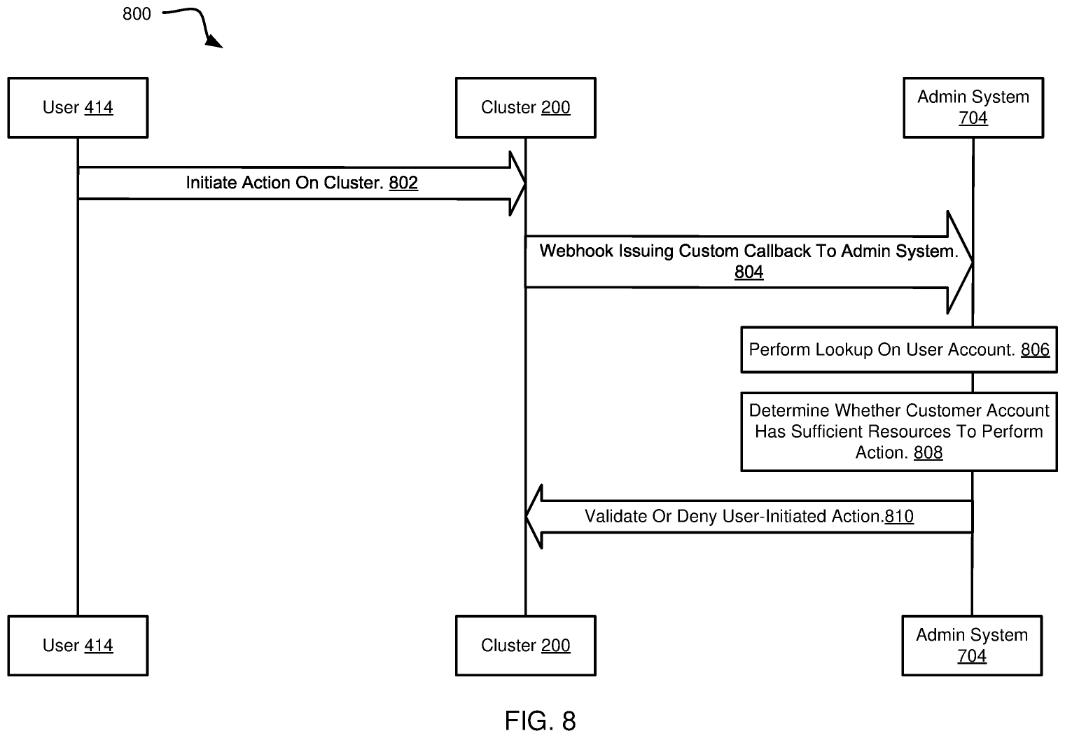

FIG. 8 is a schematic flow chart diagram of a process flow 800 for managing a customer's resource usage within a containerized workload management system such as Kubernetes. The process flow 800 is implemented by a user 414 (which may include one or more users associated with a customer account), one or more clusters 200 within the Kubernetes platform, and the administrative system 704, which is external to the Kubernetes platform.

The process flow 800 begins with the user 414 initiating an action on the cluster 200 at 802. The action may include, for example, adding a new tenant 402 to the cluster 200, causing a new application to be executed by the cluster 200, generating a new pod 508 within the cluster, allocating a new persistent volume 610 resource on the cluster, storing additional data on the cluster 200, and so forth.

The process flow 800 continues with the webhook 702 issuing a custom callback 712 to the administrative system 704 at 804. The administrative system 704 then performs a lookup on the user's account at 806 and determines whether the customer account has sufficient resources to the perform the action at 808. The determination step at 808 may be performed on the customer account as a whole (as discussed in FIG. 8) and may alternatively be performed on a user-specific account, a tenant group-specific account, and application-specific account, and so forth. The customer may elect to set specific resource limits to certain users, tenant groups, applications, pods, and so forth. The administrative system 704 may determine at 808 whether sufficient applicable resources remain for the user 414 to perform the action.

The process flow 800 continues with the administrative system 704 validating or denying the user-initiated action at 810. In an example implementation, the action initiated by the user 414 is to create a new pod 508 on the cluster 200. In this case, the administrative system 704 would perform the following determinations:

total pod resources+new pod resources<customer limits=allow Equation 1, Action Approval

total pod resources+new pod resources>customer limits=deny Equation 2, Action Denial

If the action is denied by the administrative system 704 at 810, the cluster 200 will prohibit the user 414 from performing the action. The cluster 200 cannot elect to perform the action despite the customer exceeding their resource allotment because in many cases, multiple customers are sharing the same cluster 200. If the user 414 is allowed to perform the action after the customer has exceeded their resource allotment, then other customers on the same cluster 200 may suffer. The cluster 200 and/or the administrative system 704 may automatically notify the user 414 that the action cannot be performed because the customer has exceeded their resource allotment. The user 414 may then be invited to contact the administrative system 704 to increase the resource allotment so the action can be performed.

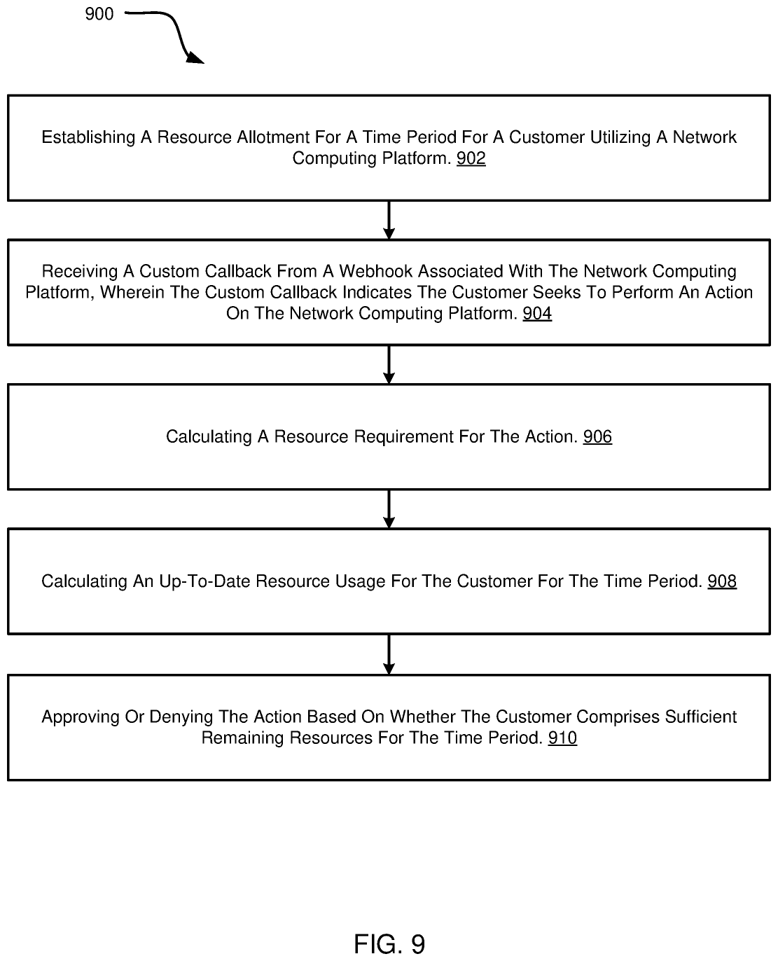

FIG. 9 is a schematic flow chart diagram of a method 900 for integrated tracking of resource usage within a network computing platform such as Kubernetes. The method 900 may be executed by an administrative system 704 as described herein, which is integrated with a cluster 200 of Kubernetes but is external to Kubernetes itself.

The method 900 begins with the administrative system 704 establishing at 902 a resource allotment for a time period for a customer utilizing a network computing platform such as Kubernetes. The resource allotment may include different itemized resource allotments for CPU, disk storage, RAM, GPU, network usage, and so forth. The resource allotment may be defined by a time period, such as a per-month or per-annum resource allotment. The resource allotment may be customer-wide and/or it may include sub-resource allotments for individual users, groups of users, members of tenant groups, or groups of users with the same role or permissions. Additionally, the resource allotment may include sub-resource allotments for different clusters 200, namespaces 508, compute nodes 102, persistent volumes 610, storage nodes 116, and so forth.

The method 900 continues with the administrative system 704 receiving at 904 a custom callback from a webhook associated with the network computing platform, wherein the custom callback indicates the customer seeks to perform an action on the network computing platform. The action may include any suitable action, such as storing additional data on the platform, generating a new namespace or pod on the platform, executing a new application on the platform, and so forth.

The method 900 continues with the administrative system 704 calculating at 906 a resource requirement for the action and then calculating at 908 an up-to-date resource usage for the customer for the time period. Again, depending on the implementation, the resource usage may be customer-wide, or it may be for certain users on the platform, or it may be for certain processing or storage constructs on the platform. The method 900 continues with the administrative system 704 approving or denying the action at 910 based on whether the customer comprises sufficient remaining resources for the time period.

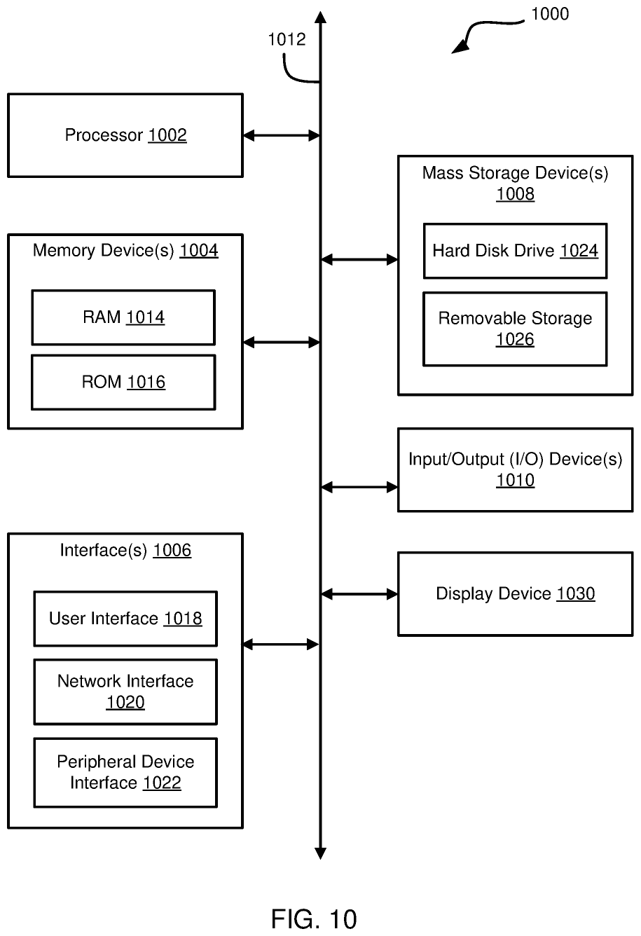

FIG. 10 illustrates a schematic block diagram of an example computing device 1000. The computing device 1000 may be used to perform various procedures, such as those discussed herein. The computing device 1000 can perform various monitoring functions as discussed herein, and can execute one or more application programs, such as the application programs or functionality described herein. The computing device 1000 can be any of a wide variety of computing devices, such as a desktop computer, in-dash computer, vehicle control system, a notebook computer, a server computer, a handheld computer, tablet computer and the like.

The computing device 1000 includes one or more processor(s) 1004, one or more memory device(s) 1004, one or more interface(s) 1006, one or more mass storage device(s) 1008, one or more Input/output (I/O) device(s) 1010, and a display device 1030 all of which are coupled to a bus 1012. Processor(s) 1004 include one or more processors or controllers that execute instructions stored in memory device(s) 1004 and/or mass storage device(s) 1008. Processor(s) 1004 may also include several types of computer-readable media, such as cache memory.

Memory device(s) 1004 include various computer-readable media, such as volatile memory (e.g., random access memory (RAM) 1014) and/or nonvolatile memory (e.g., read-only memory (ROM) 1016). Memory device(s) 1004 may also include rewritable ROM, such as Flash memory.

Mass storage device(s) 1008 include various computer readable media, such as magnetic tapes, magnetic disks, optical disks, solid-state memory (e.g., Flash memory), and so forth. As shown in FIG. 10, a particular mass storage device 1008 is a hard disk drive 1024. Various drives may also be included in mass storage device(s) 1008 to enable reading from and/or writing to the various computer readable media. Mass storage device(s) 1008 include removable media 1026 and/or non-removable media.

I/O device(s) 1010 include various devices that allow data and/or other information to be input to or retrieved from computing device 1000. Example I/O device(s) 1010 include cursor control devices, keyboards, keypads, microphones, monitors or other display devices, speakers, printers, network interface cards, modems, and the like.

Display device 1030 includes any type of device capable of displaying information to one or more users of computing device 1000. Examples of display device 1030 include a monitor, display terminal, video projection device, and the like.

Interface(s) 1006 include various interfaces that allow computing device 1000 to interact with other systems, devices, or computing environments. Example interface(s) 1006 may include any number of different network interfaces 1020, such as interfaces to local area networks (LANs), wide area networks (WANs), wireless networks, and the Internet. Other interface(s) include user interface 1018 and peripheral device interface 1022. The interface(s) 1006 may also include one or more user interface elements 1018. The interface(s) 1006 may also include one or more peripheral interfaces such as interfaces for printers, pointing devices (mice, track pad, or any suitable user interface now known to those of ordinary skill in the field, or later discovered), keyboards, and the like.

Bus 1012 allows processor(s) 1004, memory device(s) 1004, interface(s) 1006, mass storage device(s) 1008, and I/O device(s) 1010 to communicate with one another, as well as other devices or components coupled to bus 1012. Bus 1012 represents one or more of several types of bus structures, such as a system bus, PCI bus, IEEE bus, USB bus, and so forth.

For purposes of illustration, programs and other executable program components are shown herein as discrete blocks, such as block 302 for example, although it is understood that such programs and components may reside at various times in different storage components of computing device 1000 and are executed by processor(s) 1002. Alternatively, the systems and procedures described herein, including programs or other executable program components, can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to preferred features of further embodiments:

Example 1 is a method for tracking resource usage on a network computing platform such as Kubernetes. The method includes establishing a resource allotment for a time period for a customer utilizing a network computing platform. The method includes receiving a custom callback from a webhook associated with the network computing platform, wherein the custom callback indicates the customer seeks to perform an action on the network computing platform. The method includes calculating a resource requirement for the action. The method includes calculating an up-to-date resource usage for the customer for the time period. The method includes approving or denying the action based on whether the customer comprises sufficient remaining resources for the time period.

Example 2 is a method as in Example 1, wherein the resources comprises one or more of CPU (central processing unit) usage, storage usage, disk usage, network usage, or GPU (graphics processing unit) usage.

Example 3 is a method as in any of Examples 1-2, wherein establishing the resource allotment for the time period comprises establishing a customer-wide resource allotment.

Example 4 is a method as in any of Examples 1-3, wherein establishing the resource allotment for the time period comprises establishing one or more of a user-specific or a tenant group-specific resource allotment for the customer.

Example 5 is a method as in any of Examples 1-4, wherein the action comprises generating a new pod within a cluster on the network computing platform.

Example 6 is a method as in any of Examples 1-5, wherein the cluster comprises a plurality of different namespaces, and wherein the customer is associated with only a portion of the plurality of different namespaces on the cluster.

Example 7 is a method as in any of Examples 1-6, wherein each of the plurality of different namespaces on the cluster comprises one or more compute nodes and persistent volumes; and wherein each of the one or more compute nodes on each of the plurality of different namespaces comprises one or more pods for executing an application.

Example 8 is a method as in any of Examples 1-7, wherein the action comprises an indication of where the new pod will be located on the cluster, including which compute node will execute the new pod, and which namespace will comprise the new pod.

Example 9 is a method as in any of Examples 1-8, wherein the action comprises generating a new namespace within a cluster on the network computing platform.

Example 10 is a method as in any of Examples 1-9, wherein the action comprises allocating additional storage resources to a cluster on the network computing platform.

Example 11 is a method as in any of Examples 1-10, wherein the webhook is a user-defined HTTP callback between an administrative system and a cluster on the network computing platform, and wherein the administrative system is external to the network computing platform.

Example 12 is a method as in any of Examples 1-11, wherein the network computing platform is a containerized workload management system comprising: a plurality of bare metal servers; and a plurality of clusters distributed across the plurality of bare metal servers, wherein the customer executes jobs on at least one of the plurality of clusters.

Example 13 is a method as in any of Examples 1-12, wherein each of the plurality of clusters comprises: a control plane node comprising an API (application program interface) server; a plurality of compute nodes in communication with the API server of the control plane node; and one or more pods running within each of the plurality of compute nodes.

Example 14 is a method as in any of Examples 1-13, wherein the action comprises generating a new pod within one of the plurality of compute nodes.

Example 15 is a method as in any of Examples 1-14, wherein calculating the resource requirement for the action comprises calculating one or more of: a CPU requirement for generating the new pod; a RAM (random access memory) requirement for generating the new pod; or a disk storage requirement for generating the new pod.

Example 16 is a method as in any of Examples 1-15, wherein approving or denying the action comprises: approving the action only if the customer comprises sufficient remaining resources for the time period for each of a plurality of resource types; and denying the action if the action would cause the customer to exceed the resource allotment for the time period for any one of a plurality of resource types.

Example 17 is a method as in any of Examples 1-16, further comprising, in response to denying the action, issuing a notification to the customer indicating the action is denied for lack of remaining resources for the time period.

Example 18 is a method as in any of Examples 1-17, further comprising tracking the customer's resource usage on the network computing platform over time by way of the custom callback established through the webhook.

Example 19 is a method as in any of Examples 1-18, further comprising calculating a chargeback to the customer for their resource usage on the network computing platform.

Example 20 is a method as in any of Examples 1-19, further comprising establishing time-specific resource allocation for the customer to perform actions on the network computing platform; and wherein approving or denying the action is further based on a desired execution time for the action and whether the action would exceed the time-specific resource allocation to the customer.

Example 21 is a system comprising one or more processors configured to execute instructions stored in non-transitory computer readable storage medium, wherein the instructions comprise any of the method steps of Examples 1-20.

Example 22 is non-transitory computer readable storage medium comprising instructions to be executed by one or more processors, wherein the instructions comprise any of the method steps of Examples 1-20.

It will be appreciated that various features disclosed herein provide significant advantages and advancements in the art. The following claims are exemplary of some of those features.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that any features of the above-described arrangements, examples, and embodiments may be combined in a single embodiment comprising a combination of features taken from any of the disclosed arrangements, examples, and embodiments.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements.

Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Further, where appropriate, functions described herein can be performed in one or more of: hardware, software, firmware, digital components, or analog components. For example, one or more application specific integrated circuits (ASICs) or field programmable gate arrays (FPGAs) can be programmed to carry out one or more of the systems and procedures described herein. Certain terms are used throughout the following description and claims to refer to particular system components. As one skilled in the art will appreciate, components may be referred to by different names. This document does not intend to distinguish between components that differ in name, but not function.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
establishing a resource allotment for a time period for a customer utilizing a network computing platform;
receiving a custom callback from a webhook associated with the network computing platform, wherein the custom callback indicates the customer seeks to perform an action on the network computing platform;
calculating a resource requirement for the action;
calculating an up-to-date resource usage for the customer for the time period; and
approving or denying the action based on whether the customer comprises sufficient remaining resources for the time period.

2. The method of claim 1, wherein the resources comprises one or more of CPU (central processing unit) usage, storage usage, disk usage, network usage, or GPU (graphics processing unit) usage.

3. The method of claim 1, wherein establishing the resource allotment for the time period comprises establishing a customer-wide resource allotment.

4. The method of claim 1, wherein establishing the resource allotment for the time period comprises establishing one or more of a user-specific or a tenant group-specific resource allotment for the customer.

5. The method of claim 1, wherein the action comprises generating a new pod within a cluster on the network computing platform.

6. The method of claim 5, wherein the cluster comprises a plurality of different namespaces, and wherein the customer is associated with only a portion of the plurality of different namespaces on the cluster.

7. The method of claim 6, wherein each of the plurality of different namespaces on the cluster comprises one or more compute nodes and persistent volumes; and
wherein each of the one or more compute nodes on each of the plurality of different namespaces comprises one or more pods for executing an application.

8. The method of claim 7, wherein the action comprises an indication of where the new pod will be located on the cluster, including which compute node will execute the new pod, and which namespace will comprise the new pod.

9. The method of claim 1, wherein the action comprises generating a new namespace within a cluster on the network computing platform.

10. The method of claim 1, wherein the action comprises allocating additional storage resources to a cluster on the network computing platform.

11. The method of claim 1, wherein the webhook is a user-defined HTTP callback between an administrative system and a cluster on the network computing platform, and wherein the administrative system is external to the network computing platform.

12. The method of claim 11, wherein the network computing platform is a containerized workload management system comprising:
a plurality of bare metal servers; and
a plurality of clusters distributed across the plurality of bare metal servers, wherein the customer executes jobs on at least one of the plurality of clusters.

13. The method of claim 12, wherein each of the plurality of clusters comprises:
a control plane node comprising an API (application program interface) server;
a plurality of compute nodes in communication with the API server of the control plane node; and
one or more pods running within each of the plurality of compute nodes.

14. The method of claim 13, wherein the action comprises generating a new pod within one of the plurality of compute nodes.

15. The method of claim 14, wherein calculating the resource requirement for the action comprises calculating one or more of:
a CPU requirement for generating the new pod;
a RAM (random access memory) requirement for generating the new pod; or a disk storage requirement for generating the new pod.

16. The method of claim 1, wherein approving or denying the action comprises:
approving the action only if the customer comprises sufficient remaining resources for the time period for each of a plurality of resource types; and
denying the action if the action would cause the customer to exceed the resource allotment for the time period for any one of a plurality of resource types.

17. The method of claim 1, further comprising, in response to denying the action, issuing a notification to the customer indicating the action is denied for lack of remaining resources for the time period.

18. The method of claim 1, further comprising tracking the customer's resource usage on the network computing platform over time by way of the custom callback established through the webhook.

19. The method of claim 18, further comprising calculating a chargeback to the customer for their resource usage on the network computing platform.

20. The method of claim 1, further comprising establishing time-specific resource allocation for the customer to perform actions on the network computing platform; and
wherein approving or denying the action is further based on a desired execution time for the action and whether the action would exceed the time-specific resource allocation to the customer.
